(19) United States
(12) Patent Application Publication
(10) Pub. No.: US 2010/0075080 A1
(43) Pub. Date: Mar. 25, 2010

(54) MOUNTABLE DECORATIVE HOLDER FOR DISPLAYING INTERCHANGEABLE PRINTED MATERIAL

(76) Inventor: Damon Ross Martin, Marietta, GA (US)

Correspondence Address: GEORGE R. REARDON, 3356 STATION COURT, LAWRENCVILLE, GA, 30044, US

(21) Appl. No.: 12/235,315

(22) Filed: Sep. 22, 2008

(51) Int. Cl. B32B 1/02; B23P 11/00

(52) U.S. Cl. 428/35.6; 428/34.1; 428/35.7; 29/428

(57) ABSTRACT

A mountable decorative holder for displaying removeable signage is provided. The holder has one or more gaps at the bottom of the signage recess of the holder to allow for drainage of liquids, as well as removal of debris. Holders can be constructed using a variety of materials, e.g. plastic, acrylic, clear, plexiglass, wood, solid surface, composites, for a variety of uses, e.g. architectural, schools, churches, offices, factories, military, wholesale, retail.

### FIELD OF THE INVENTION

The technology described herein relates generally to the field of display holders for walls, doors, windows and other surfaces.

### BACKGROUND OF THE INVENTION

Signage is any kind of graphics created to display information to a particular audience. Indoor signage for classrooms, conference rooms, auditoriums, entrances, factories, multipurpose rooms, and the like, is used to provide information for individuals and groups.

Signage can be permanent or temporary. Signage can be mounted directly to a surface. While this surface is traditionally a vertical surface, e.g. a wall, a door or a window, it may be a separate structure on a horizontal surface, e.g. a floor, a desk.

The need for changing signage in a variety of environments has created several solutions in the marketplace, including various holders of signage.

### BRIEF SUMMARY OF THE INVENTION

In various exemplary embodiments, the technology described herein provides a durable custom display and sign holder (a pocket) constructed using a variety of materials, e.g. plastic, acrylic, clear, plexiglass, wood, solid surface, composites, for a variety of uses, e.g. architectural, schools, churches, offices, factories, military, wholesale, retail.

In an exemplary embodiment the mountable decorative holder is an acrylic holder for standard 8.5 inch by 11 inch inserts, i.e., a PlexiPocket.

The PlexiPocket can be in either a portrait design or a landscape design.

The PlexiPocket is made with an acrylic back plate (a backer). The backer can be clear or be formed with one or more acrylic colors, as desired, and has a thickness ranging from ⅛″ to ¼″. The backer can be formed with or without a header for labeling, e.g., room labeling. Header sizes can range from zero to 3″ in height and can be formed with either square or rounded corners.

The PlexiPocket face plate is made from clear acrylic or polycarbonate, with a gloss or a non-glare finish. The face plate ranges in thickness from ⅛″ to ¼″. The face plate can be formed with or without a half circle thumb notch cut out of the material on the opening edge for insert retrieval.

The depth of the PlexiPocket pocket recess is determined by the side support rods. The side support rods consist of acrylic cut to the length of the sides of the face plate, ranging in thickness from ⅛″ to ½″ and in width from ⅛″ to 1″. A bottom side piece (bottom support rod) of the PlexiPocket is formed shorter than the length of the bottom sides of the backer and face plate to allow for one or two openings (gaps) along that side, depending on the positioning of the bottom support rod. (Compressed air can be directed into a gap from underneath a pocket in order to dislodge any debris that may be in the recess, or pocket, e.g. a paper clip, a cigarette, an insect. In addition, in certain environments a pocket may be cleaned with water after signage has been removed, and the gap(s) allow for the water to drain away).

The PlexiPocket is constructed by adhering the side support rods between the face plate and the backer so that the side support rods are flush to the edge of the face plate and the backer. One side of the PlexiPocket is left open for the insertion of signage. This is normally the side having the header and/or the thumb notch (but can be one of the sides if it is desired to insert the signage from the side rather than the top). The opposing or bottom side is constructed so that the position of the bottom support rod leaves an opening on either one or both ends of the bottom support rod.

Construction of the PlexiPocket is achieved by welding all of the elements together with either liquid or solid acrylic adhesives or solvents.

The constructed pocket's edges are then smoothed by planning or sanding and can be finished by polishing or flaming.

The front of the face plate can be decorated with a border color, e.g., consisting of vinyl adhesive striping or by screen printing on the surface. Borders can range in width from ¼″ to ¾″ and can be on three or four sides of the front of the face plate.

The header can be labeled, e.g., using vinyl adhesive material cut with the desired information, decaled with printed adhesive material, screen printed with the desired user information, or the like.

The PlexiPocket is mounted, e.g., using double-faced tape, with keyhole slots attached to the back of the pocket, by drilling two holes in the header (one on each side) for screw mounting.

If desired, the pocket can have ADA (Americans with Disabilities Act) labeling. ADA labeling provides ⅝″ high× 1/16″ thick raised letters/numbers and 1/32″ thick raised Braille dots. The letters and/or numbers are adhesive mounted to the header. The Braille dots are etched out of the backer using a computerized router.

In another embodiment an easel style or table top stand PlexiPocket is formed for table mounting.

In another embodiment wall mount brackets are available for perpendicular mounting if desired by a user.

In yet another embodiment a PlexiPocket is formed in one of two styles: landscape, for 8.5″ height×11″ width inserts, or portrait, for 11″ height×8.5″ width inserts.

In one embodiment the backer of the PlexiPocket is constructed of ⅛″ white acrylic cut to 9.25″ width×12.75″ height for portrait style or 11.75″ width×10.25″ height for landscape style. The top two corners of the backer are rounded and the bottom two corners are square. The face plate is constructed of ⅛″ clear acrylic cut to 9.25″ width×11.25″ height for portrait style and 11.75″ width×8.75″ height, for landscape style. All four corners are square. There is a 1″ half circle notch located on the center of the top edge of the face plate. The sides of the pocket are constructed of ¼″ acrylic square rod. The side support rods (side rods) are cut to the length of the side of the face plate. The bottom side piece (bottom support rod) is cut two inches shorter than the length of the bottom edge of the face plate. The backer and the front plate are welded to the ¼″ square rod by placing one backer and one face plate on opposing sides of the ¼″ square rod. The side rods are placed flush to the edge of the backer starting at the bottom square corners and are welded to the backer using a liquid weld solvent applied to the rods where the rods meet the backer. The bottom rod is placed flush to the edge of the bottom of the backer in the center of the plate leaving a ¾″ gap on both sides. The rod is secured using a liquid weld solvent applied to the rods where the rod meets the backer. The face plate is attached to the rods by aligning the face plate over the rods flush to the bottom and side edges. The face plate is then attached using a liquid weld solvent applied to all three side rods where the rods meet the face plate. All four edges of the constructed pocket are then shaped until all pieces are flush and smooth. The face plate is then accented with ½′ vinyl striping applied flush to the edge on both sides and bottom of the front surface of the face plate. If desired labeling is added to the header using pressure sensitive vinyl cut with the desired information.

In yet another embodiment, a “solid surface” (CORIAN) pocket has an acrylic holder on a solid surface backer for standard 8.5×11 inserts. The solid surface pocket can be in either portrait or landscape design.

The solid surface pocket is made with a solid surface backer having a ½″ thickness. The backer is cut larger than the face plate to leave a reveal of the solid surface material. In one embodiment the solid surface wall pocket has square corners at the bottom and a curved section at the top. The edges are rounded over and sanded to a smooth finish. The back side of the solid surface backer is supplied with two keyhole slots for screw mounting.

A table top easel can be affixed to the backer for table top mounting.

The face plate is made from ⅛″ clear acrylic or polycarbonate in gloss or non glare finish. The face plate can be formed with a half circle thumb notch cut out of the material on the opening edge for insert retrieval.

The depth of the pocket recess is determined by the side support rods which consist of acrylic cut to the length of the sides of the face plate in ¼″ thickness. The bottom support rod of the pocket is cut 2″ shorter than the length of that side to allow two openings along that side by centering that piece on the bottom edge of the face plate.

The pocket is constructed by joining the side support rods to the front face plate so that the side support rods are flush to the edge of the front plate. The side rods are placed flush to the edge of the front plate and are welded to the front plate using a liquid weld solvent applied to the rods where the rods meet the front plate. The bottom rod is placed flush to the edge of the bottom of the front plate in the center of the plate leaving a ¾″ gap on both sides. The rod is secured using a liquid weld solvent applied to the rods where the rod meets the front plate.

The top side is left open. This is the side with the thumb notch.

The constructed face plate's edges are then sanded to a smooth finish.

The face plate is adhered to the solid surface backer using VHB (very high bond) adhesive tape.

The face plate is centered on the backer with equal spacing on three sides leaving the top space available for header labeling.

The front of the face plate is decorated with a border of color consisting of ½″ vinyl adhesive striping applied to the surface of the face plate flush to the edge of the sides and bottom of the face plate.

The header can be labeled using vinyl adhesive material cut to form the desired information, decaled with printed adhesive material or screen printed with the customer information.

The solid surface pocket can have ADA compliant labeling.

The ADA labeling provides ⅝″ high× 1/16″ thick raised letters/numbers and 1/32″ thick raised Braille dots. The letters/numbers are adhesive mounted to the header. The Braille dots are etched out of the backer using a computerized router.

In still another embodiment a “metal” wall pocket has an acrylic holder on a metal, e.g. aluminum, brass, copper, stainless steel, finished backer for standard 8.5×11 inserts.

Metal pockets can be in both portrait and landscape design.

The metal pocket is made with a metal finished backer ⅛″ thickness. The backer is cut with square corners on the bottom two corners and rounded corners for the top two corners.

The back side of the metal backer is supplied with two lengths of double faced tape for mounting.

The face plate is made from ⅛″ clear acrylic or polycarbonate in gloss or non glare finish. The face plate comes with a half circle thumb notch cut out of the material on the opening edge for insert retrieval.

The depth of the pocket is determined by the side support rods which consist of acrylic cut to the length of the sides of the face plate in ¼″ thickness. The bottom support rod of the pocket is cut 2″ shorter than the length of that side to allow two openings along that side by centering that piece on the bottom edge of the face plate.

The pocket is constructed by joining the side support rods to the front face plate so that the side support rods are flush to the edge of the front plate. The side rods are placed flush to the edge of the front plate and are welded to the front plate using a liquid weld solvent applied to the rods where the rods meet the front plate. The bottom rod is placed flush to the edge of the bottom of the front plate in the center of the plate leaving a ¾″ gap on both sides. The rod is secured using a liquid weld solvent applied to the rods where the rod meets the front plate.

The top side is left open. This is the side with the thumb notch.

The constructed face plate's edges are then sanded to a smooth finish.

The face plate is adhered to the metal backer using VHB adhesive tape.

The face plate is centered on the backer with equal spacing on three sides leaving the top space available for header labeling.

The front of the face plate is decorated with a border of color consisting of ½″ vinyl adhesive striping applied to the surface of the face plate flush to the edge of the sides and bottom of the face plate.

The header can be labeled using vinyl adhesive material cut to the desired information, decaled with printed adhesive material or screen printed with the customer information.

In another embodiment of the technology described herein a “WoodPocket” has an acrylic holder on a solid wood backer for standard 8.5×11 inserts. WoodPockets can be in both portrait and landscape design.

The Wood Pocket is made with a solid wood backer, e.g. walnut, oak, in 1″ thickness. The backer is cut with either square or rounded corners and has rounded edges for a finished look. The back side of the solid wood backer is supplied with two keyhole slots for screws and two lengths of double faced tape for mounting.

The face plate is made from ⅛″ clear acrylic or polycarbonate in gloss or non glare finish. The face plate comes with a half circle thumb notch cut out of the material on the opening edge for insert retrieval.

The depth of the pocket is determined by the side support rods which consist of acrylic cut to the length of the sides of the face plate in ¼″ thickness. The bottom support rod of the pocket is cut shorter than the length of that side to allow two openings along that side by centering that piece on the bottom edge of the face plate.

The pocket is constructed by joining the side support rods to the front face plate so that the side support rods are flush to the edge of the front plate. One side is left open. This is the side with the thumb notch. The opposing or bottom side is constructed so that the position of the bottom support rod leaves an opening on both ends of the bottom support rod.

Face plate construction can be achieved by joining the pieces together with liquid acrylic solvents. The constructed face plate's edges are then sanded to a smooth finish. The face plate is adhered to the wood backer using VHB adhesive tape.

The front of the face plate is decorated with a border of color consisting of ½″ vinyl adhesive striping applied to the surface of the face plate flush to the edge of the sides and bottom of the face plate.

The header can be labeled using vinyl adhesive material cut to form the desired information, decaled with printed adhesive material or screen printed with the customer information. The WoodPocket can have ADA (Americans with Disabilities Act) compliant labeling.

In another embodiment a “MultiPocket” has a single piece of backer material custom sized to accept multiple pockets for displaying more than one insert at a time on the same backer. There is no limit to the number of pockets, provided they will fit on the backer. Backer sizes are limited to available material sizes.

A MultiPocket is generally 48″×96″ or less for Acrylic, Wood or Metal and 30″×72″ for Solid Surface.

Insert sizes are limited to a maximum size of 18″×24″.

Advantageously, the technology described herein provides the ability for a user to print a new sign, e.g. using a computer, and to insert the new sign into the holder, thus saving money.

Advantageously, the technology described herein provides a wall mount sign holder that is easy to install,

Advantageously, the technology described herein provides the ability for a sign holder that can be customized and its border can be color coordinated with a user's décor, thus enhancing the user's environment.

Advantageously, the technology described herein provides the ability for presenting signage in a professional manner.

Advantageously, the technology described herein requires no special tools to change inserted signage.

Advantageously, the technology described herein provides the ability for insertion of multiple inserts.

Advantageously, the technology described herein provides the ability for the consumer to permanently mount a decorative holder on the wall and insert their own printed signage at any time.

Advantageously, the technology described herein provides the ability for a background color, design, or material of the user's choice.

Advantageously, the technology described herein provides for optional labeling.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. For example, embodiment sizes may include 8.5″×14″, 11″×14″, and 11″×17″. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of an assembled PlexiPocket having inserted material, according to an embodiment of the technology;

FIG. 2 is a perspective view of an assembled PlexiPocket without any inserted material, according to an embodiment of the technology;

FIG. 3 is a partially exploded view of a PlexiPocket, according to an embodiment of the technology;

FIG. 4 is a top plan view of the PlexiPocket of FIG. 2, according to an embodiment of the technology;

FIG. 5 is a bottom plan view of a PlexiPocket of FIG. 2, according to an embodiment of the technology;

FIG. 6 is a perspective view of a perpendicular wall mount PlexiPocket, according to an embodiment of the technology;

FIG. 7 is a perspective view of a solid surface pocket having a table top stand, according to an embodiment of the technology;

FIG. 8 is a right side plan view of the solid surface pocket of FIG. 7, according to an embodiment of the technology;

FIG. 9A is a front plan view of a wall mount PlexiPocket having a header, according to an embodiment of the technology;

FIG. 9B is a right side plan view of a backer for FIG. 9A, according to an embodiment of the technology;

FIG. 9C is a right side plan view of a bottom support rod for FIG. 9A, according to an embodiment of the technology;

FIG. 9D is a right side plan view of a side support rod for FIG. 9A, according to an embodiment of the technology;

FIG. 9E is a right side plan view of a face plate for FIG. 9A, according to an embodiment of the technology;

FIG. 10A is a front plan view of a wall mount PlexiPocket with no header, according to an embodiment of the technology;

FIG. 10B is a right side plan view of a backer for FIG. 10A, according to an embodiment of the technology;

FIG. 10C is a right side plan view of a bottom support rod for FIG. 10A, according to an embodiment of the technology;

FIG. 10D is a right side plan view of a side support rod for FIG. 10A, according to an embodiment of the technology;

FIG. 10E is a right side plan view of a face plate for FIG. 10A, according to an embodiment of the technology;

FIG. 11A is a right side plan view of a table mounted PlexiPocket, according to an embodiment of the technology;

FIG. 11B is a front plan view of the table mounted PlexiPocket of FIG. 11C, according to an embodiment of the technology;

FIG. 11C is a right side plan view of a table mounted PlexiPocket having a perpendicular orientation, according to an embodiment of the technology;

FIG. 12A is a front plan view of a solid surface pocket having a landscape orientation, according to an embodiment of the technology;

FIG. 12B is a right side plan view of the header of FIG. 12A, according to an embodiment of the technology;

FIG. 12C is a right side plan view of the bottom support rod of FIG. 12A, according to an embodiment of the technology;

FIG. 12D is a right side plan view of the side support rod of FIG. 12A, according to an embodiment of the technology;

FIG. 12E is a right side plan view of the face plate of FIG. 12A, according to an embodiment of the technology;

FIG. 13A is a front plan view of a WoodPocket having a landscape orientation, according to an embodiment of the technology;

FIG. 13B is a right side plan view of the header of FIG. 13A, according to an embodiment of the technology;

FIG. 13C is a right side plan view of the bottom support rod of FIG. 13A, according to an embodiment of the technology;

FIG. 13D is a right side plan view of the side support rod of FIG. 13A, according to an embodiment of the technology;

FIG. 13E is a right side plan view of the face plate of FIG. 13A, according to an embodiment of the technology;

FIG. 14A is a front plan view of a metal pocket having a landscape orientation, according to an embodiment of the technology;

FIG. 14B is a right side plan view of the header of FIG. 14A, according to an embodiment of the technology;

FIG. 14C is a right side plan view of the bottom support rod of FIG. 14A, according to an embodiment of the technology;

FIG. 14D is a right side plan view of the side support rod of FIG. 14A, according to an embodiment of the technology;

FIG. 14E is a right side plan view of the face plate of FIG. 14A, according to an embodiment of the technology;

FIG. 15 is a perspective view of a multi-pocket having pockets in a landscape orientation, according to an embodiment of the technology;

FIG. 16 is a perspective view of a wood pocket having ADA compliant labeling, according to an embodiment of the technology; and

FIG. 17 is a detailed view of the ADA compliant labeling, according to an embodiment of the technology.

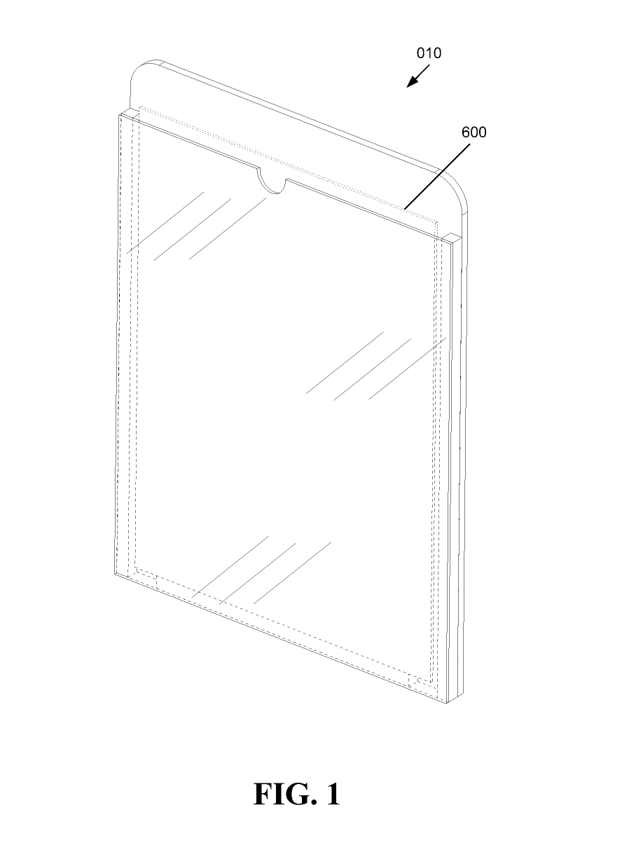

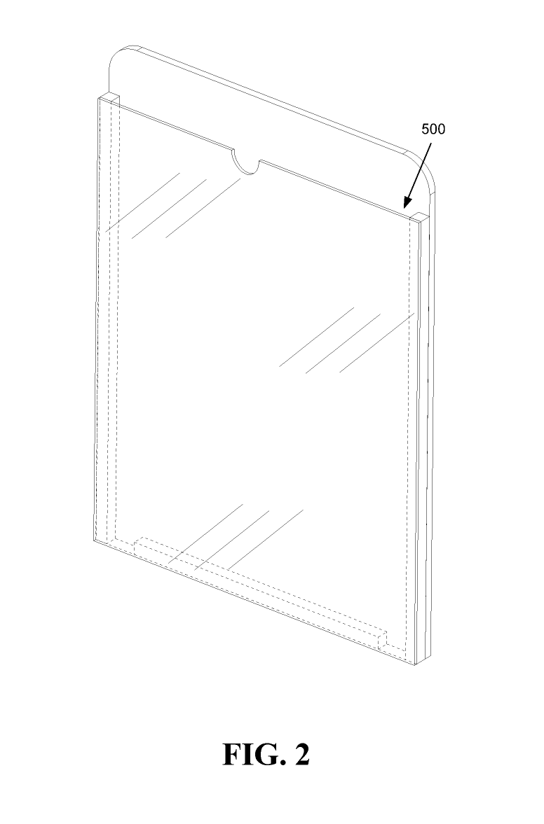

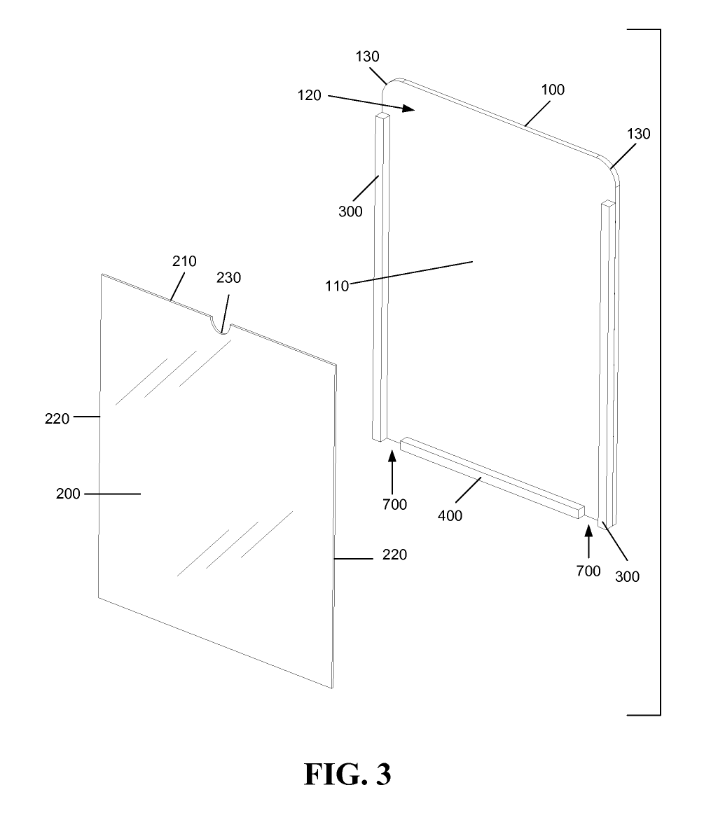

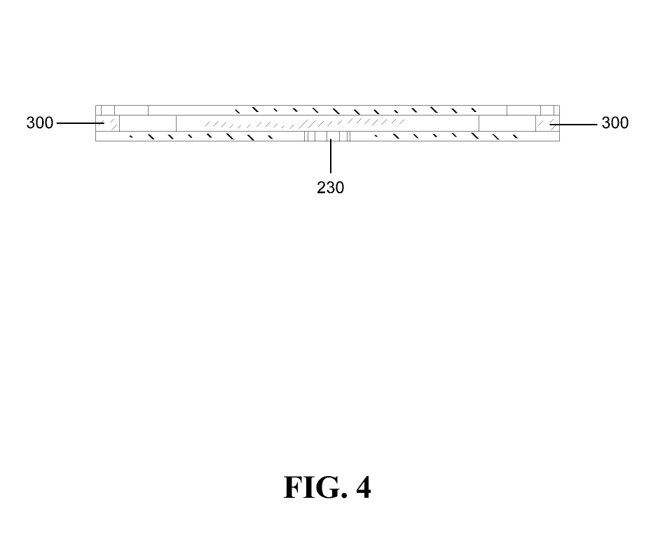

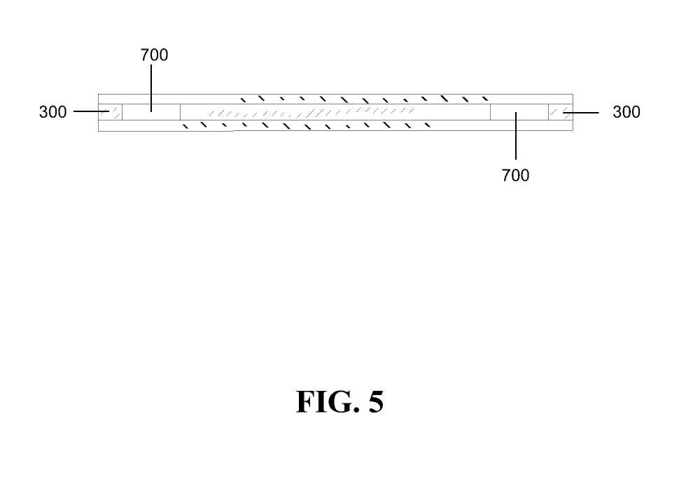

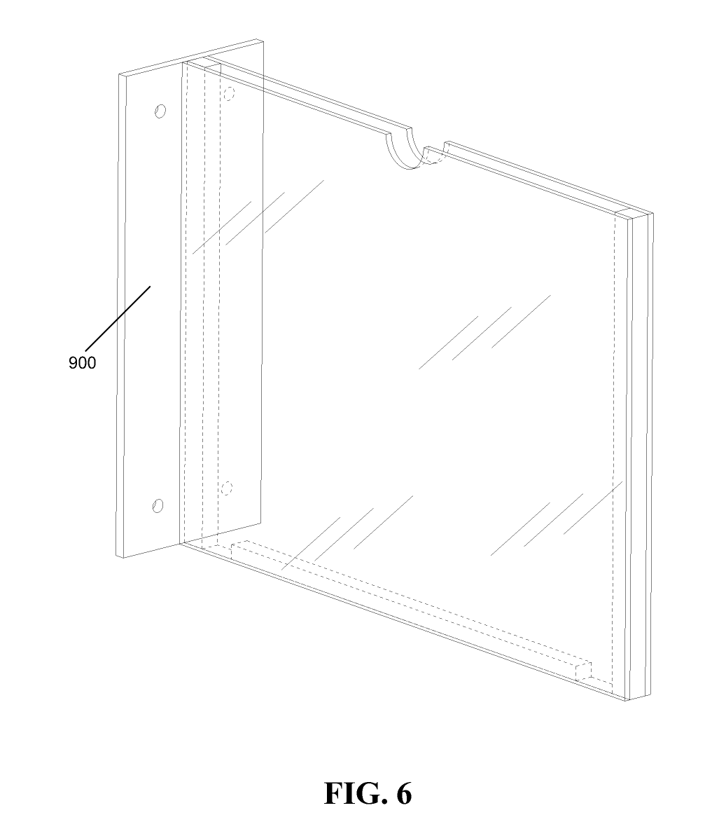

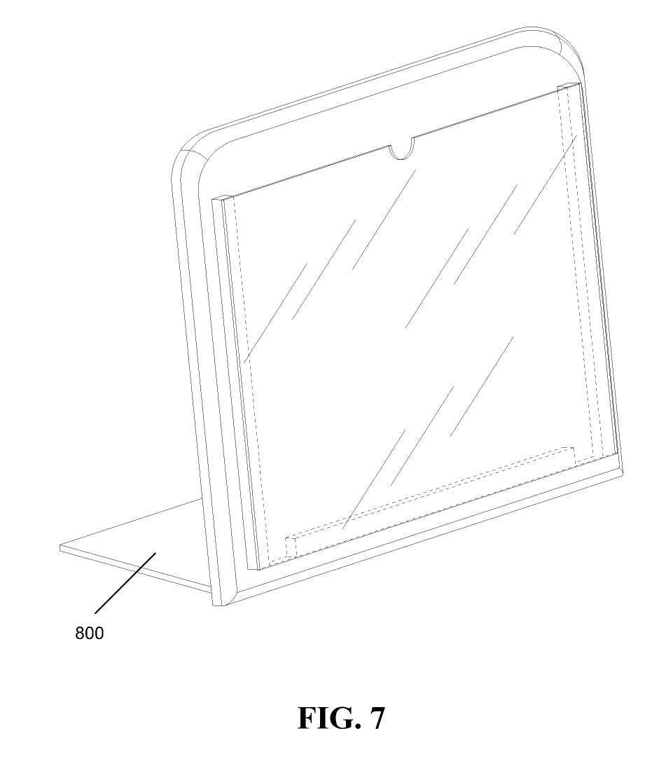

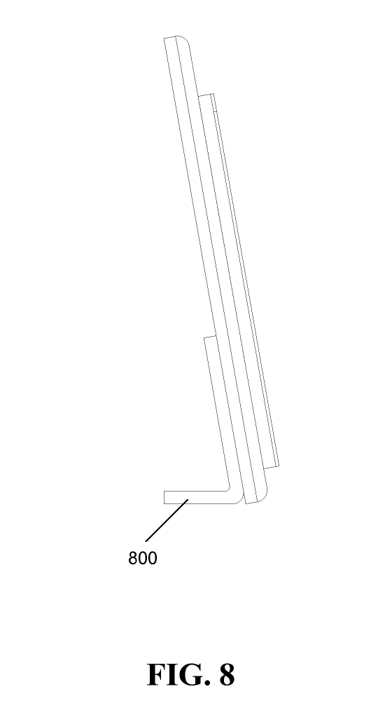

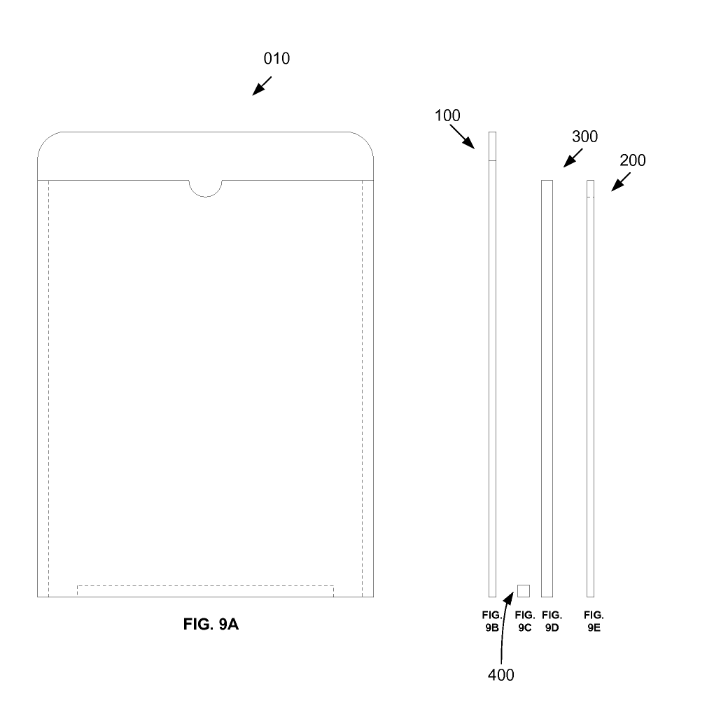

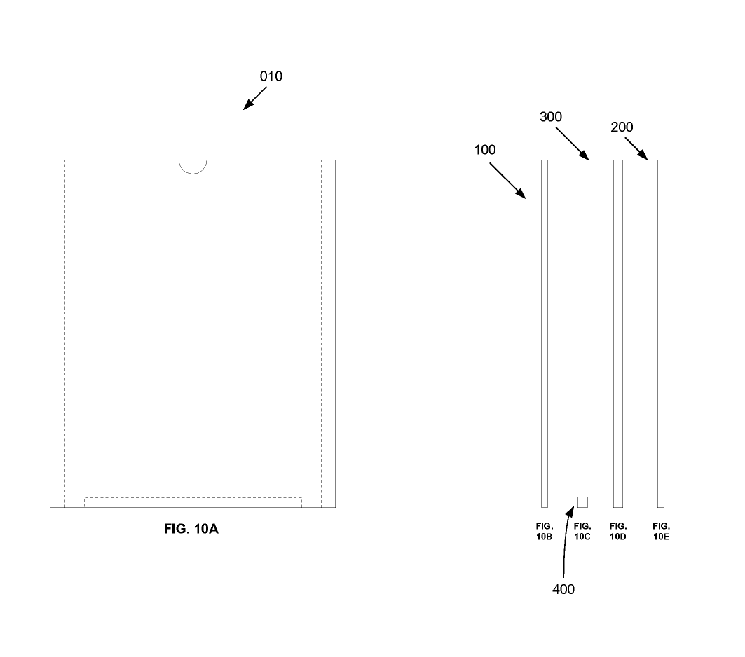

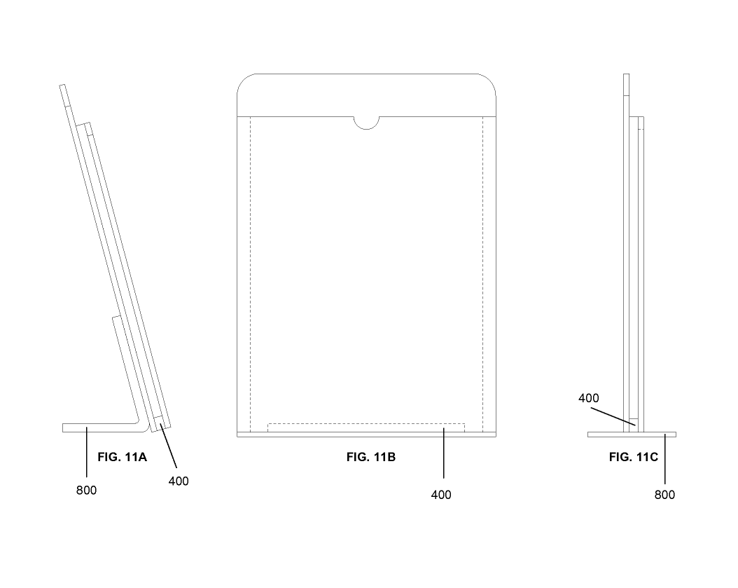

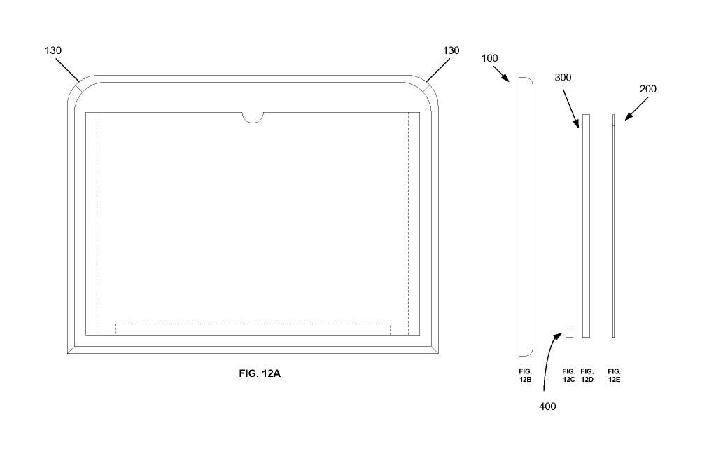

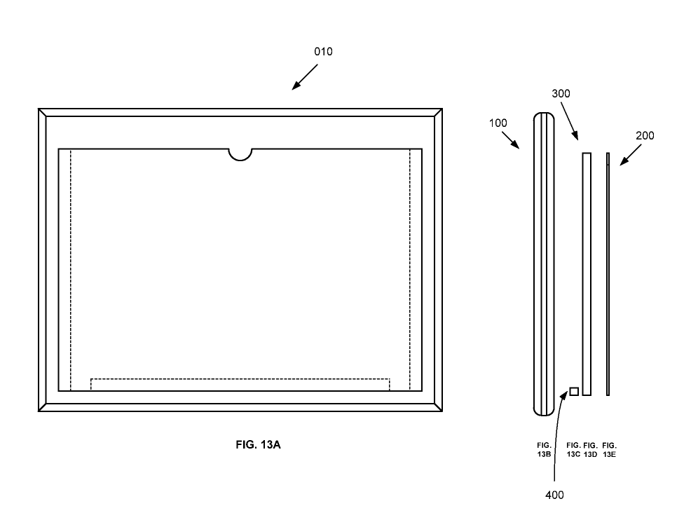

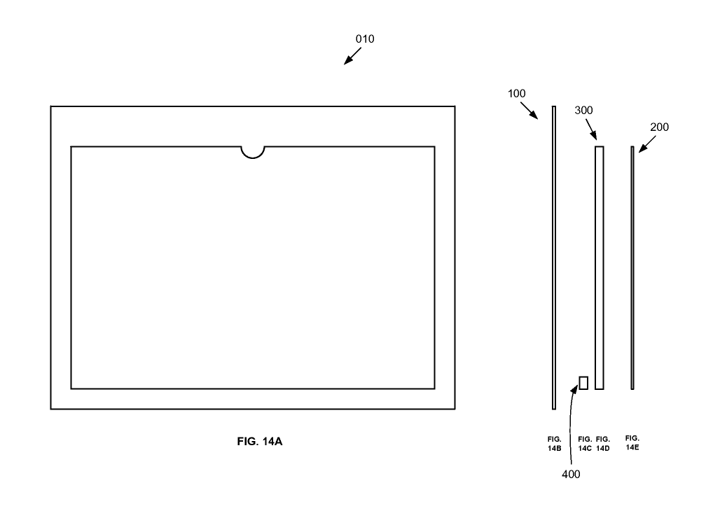

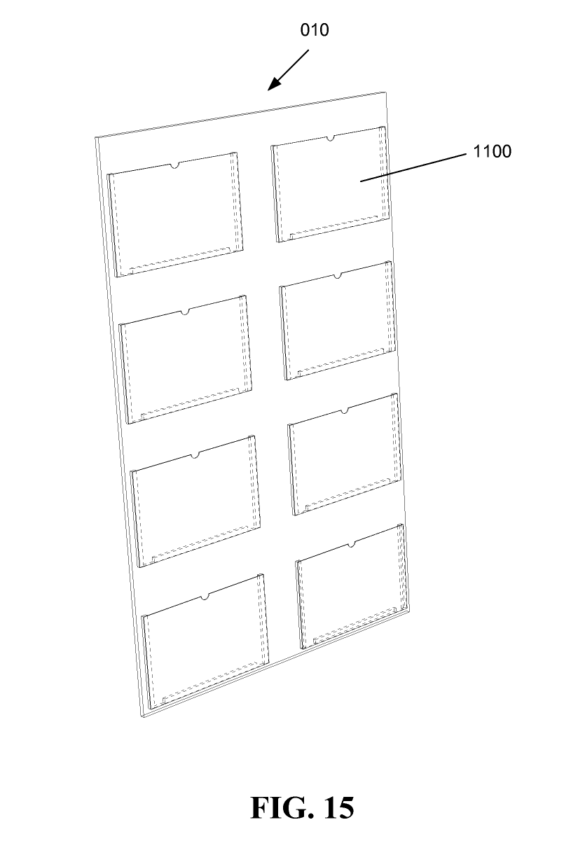

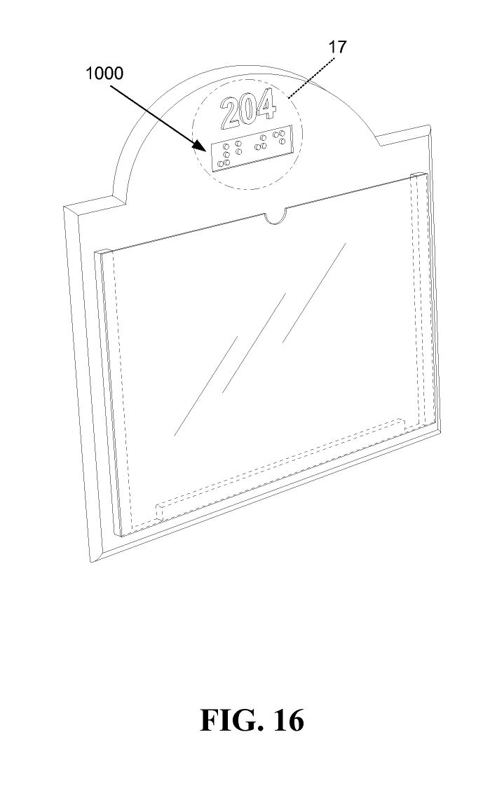

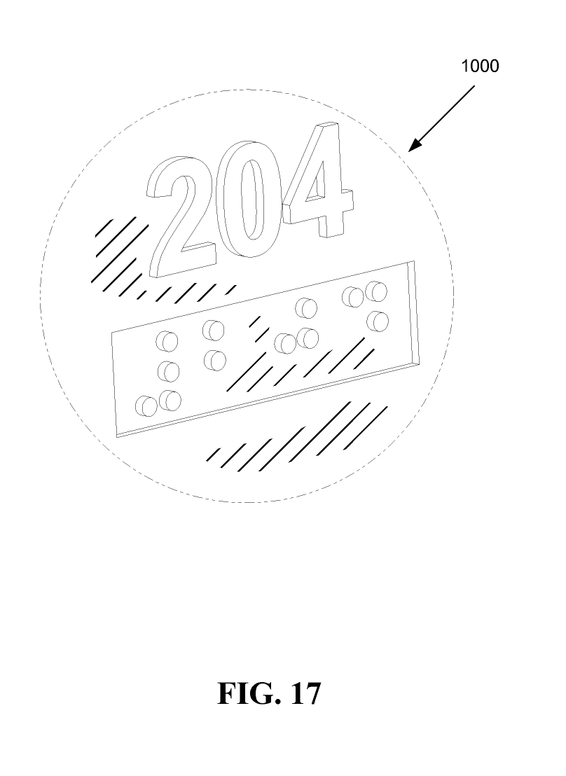

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

The technology described herein is directed to providing a mountable decorative holder for at least one insertable signage.

By way of example, in one embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600; and the face plate 200 further comprises a notched cut-out 230 along an edge of the face plate 200 to facilitate the interchangeability of the printed material 600.

In yet another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600 and the face plate 200 is one of a clear acrylic glass and a polycarbonate.

In still another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600 and the face plate 200 comprises one of a gloss and a non-glare finish.

In one embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, and the face plate 200 comprises a decorative pattern disposed within the face plate 200.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and a border, the border disposed on the face plate 200 and covering an at least one outer edge of the interchangeable printed material 600, configured to match the interchangeable printed material 600 and surrounding décor; configured to provide an aesthetically pleasing appearance, where the mountable decorative holder 010 is accessible without tools to interchange printed material 600.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, further comprising a border, the border disposed on the face plate 200 and covering an at least one outer edge of the interchangeable printed material 600, configured to match the interchangeable printed material 600 and surrounding décor, and configured to provide an aesthetically pleasing appearance, where the border comprises a vinyl adhesive strip applied to the face plate 200 and covering a view of a left, right, and bottom edge of the interchangeable printed material 600 inserted behind the face plate 200.

In still another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the backer 100 further comprises a header portion 120, the header portion 120 configured for a caption or label.

In one embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the backer 100 further comprises an at least one keyhole slot disposed within a rear side of the backer 100 with which to mount the mountable decorative holder 010 to a planar surface.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the backer 100 further comprises an at least one double-faced adhesive strip disposed upon a rear side of the backer 100 with which to mount the mountable decorative holder 010 to a planar surface.

In yet another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the backer 100 further comprises radius edged corners 130.

In one embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the backer 100 is one of wood, acrylic solid surface, acrylic glass, steel, brass, copper, and aluminum finish.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the pair of side support rods 300 and the bottom support rod 400 are acrylic glass.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the mountable decorative holder 010 is configured for use in both portrait and landscape configurations.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the pair of side support rods 300 and the bottom support rod 400 are secured to the backer 100 and face plate 200 with a liquid weld solvent.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600, where the pair of side support rods 300 and the bottom support rod 400 are secured to the backer 100 with an adhesive tape, and where the pair of side support rods 300 and the bottom support rod 400 are secured to the face plate 200 with a liquid weld solvent.

In still another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600; and an easel stand upon which to mount the mountable decorative holder 010 for display on top of a planar surface underneath a base of the easel stand.

In yet another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600; and a perpendicular mount, where the mountable decorative holder 010 is configured for mounting perpendicular to a planar surface in the perpendicular mount.

In another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600; and a plurality of face plates 200; and a plurality of pockets disposed upon the backer 100, created from a plurality of side support rods 300 and a plurality of bottom support rods 400, such that multiple items are displayed in the mountable decorative holder 010.

In yet another embodiment the technology described herein includes a mountable decorative holder 010 for displaying interchangeable printed material 600, the holder 010 comprising a backer 100, the backer 100 being mountable to a planar surface; a face plate 200, the face plate 200 being one of equal to or less in both width and length than the backer 100 and being generally clear such that any interchangeable printed material 600 disposed between the backer 100 and the face plate 200 is viewable through the face plate 200; a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind one of a top 210 or side 220 of the face plate 200 of the mountable decorative holder 010 in which to place the interchangeable printed material 600, the bottom support rod 400 being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material 600; and a Braille identifier disposed upon the mountable decorative holder 010 to enable the seeing impaired.

The technology described herein further encompasses a method for interchangeably displaying interchangeable printed material 600, the method comprising: utilizing a mountable decorative holder 010 for displaying interchangeable printed material 600 comprising: a backer 100, the backer 100 being mountable to a planar surface; a face plate 200, the face plate 200 being less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind a top of the face plate 200 of the mountable decorative holder 010 in which to place the interchangeable printed material 600, the bottom support rod being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material; mounting the decorative holder 010 to a planar surface; and inserting an interchangeable printed material 600 for display within the mountable decorative holder 010.

In a further embodiment the technology described herein further encompasses a method for interchangeably displaying interchangeable printed material 600, the method comprising: utilizing a mountable decorative holder 010 for displaying interchangeable printed material 600 comprising: a backer 100, the backer 100 being mountable to a planar surface; a face plate 200, the face plate 200 being less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind a top of the face plate 200 of the mountable decorative holder 010 in which to place the interchangeable printed material 600, the bottom support rod being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material; mounting the decorative holder 010 to a planar surface; inserting an interchangeable printed material 600 for display within the mountable decorative holder 010; and mounting the decorative holder 010 to a planar surface comprising an easel stand.

In a further embodiment the technology described herein further encompasses a method for interchangeably displaying interchangeable printed material 600, the method comprising: utilizing a mountable decorative holder 010 for displaying interchangeable printed material 600 comprising: a backer 100, the backer 100 being mountable to a planar surface; a face plate 200, the face plate 200 being less in both width and length than the backer 100 and being generally clear such that any interchangeable printed material 600 disposed between the backer 100 and the face plate 200 is viewable through the face plate 200; and a pair of side support rods 300 and a bottom support rod 400 disposed upon a front surface 110 of the backer 100 and upon which the face plate 200 is disposed, thereby forming a thin pocket 500 accessible from in front of the backer 100 and immediately behind a top of the face plate 200 of the mountable decorative holder 010 in which to place the interchangeable printed material 600, the bottom support rod being less than a width of the face plate 200 disposed upon it such that at least one gap 700 is formed along a bottom of the pocket of the mountable decorative holder 010, thereby providing an opening through which to remove accumulated debris with water or compressed air; and where the mountable decorative holder 010 is accessible without tools to interchange printed material; mounting the decorative holder 010 to a planar surface; inserting an interchangeable printed material 600 for display within the mountable decorative holder 010; and mounting the decorative holder to a planar surface, where the decorative holder 010 is perpendicular to the planar surface.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A mountable decorative holder for displaying interchangeable printed material, the holder comprising:
a backer, the backer being mountable to a planar surface;
a face plate, the face plate being one of equal to or less in both width and length than the backer and being generally clear such that any interchangeable printed material disposed between the backer and the face plate is viewable through the face plate; and
a pair of side support rods and a bottom support rod disposed upon a front surface of the backer and upon which the face plate is disposed, thereby forming a thin pocket accessible from in front of the backer and immediately behind one of a top or side of the face plate of the mountable decorative holder in which to place the interchangeable printed material, the bottom support rod being less than a width of the face plate disposed upon it such that at least one gap is formed along a bottom of the pocket of the mountable decorative holder, thereby providing an opening through which to remove accumulated debris with water or compressed air; and
wherein the mountable decorative holder is accessible without tools to interchange printed material.

2. The mountable decorative holder of claim 1, wherein the face plate further comprises a notched cut-out along an edge of the face plate to facilitate the interchangeability of the printed material.

3. The mountable decorative holder of claim 1, wherein the face plate is one of a clear acrylic glass and a polycarbonate.

4. The mountable decorative holder of claim 1, wherein the face plate comprises one of a gloss and a non-glare finish.

5. The mountable decorative holder of claim 1, wherein the face plate comprises a decorative pattern disposed within the face plate.

6. The mountable decorative holder of claim 1, further comprising:
a border, the border disposed on the face plate and covering an at least one outer edge of the interchangeable printed material, configured to match the interchangeable printed material and surrounding décor, and configured to provide an aesthetically pleasing appearance.

7. The mountable decorative holder of claim 6, wherein the border comprises a vinyl adhesive strip applied to the face plate and covering a view of a left, right, and bottom edge of the interchangeable printed material inserted behind the face plate.

8. The mountable decorative holder of claim 1, wherein the backer further comprises a header portion, the header portion configured for a caption or label.

9. The mountable decorative holder of claim 1, wherein the backer further comprises an at least one keyhole slot disposed within a rear side of the backer with which to mount the mountable decorative holder to a planar surface.

10. The mountable decorative holder of claim 1, wherein the backer further comprises an at least one double-faced adhesive strip disposed upon a rear side of the backer with which to mount the mountable decorative holder to a planar surface.

11. The mountable decorative holder of claim 1, wherein the backer further comprises radius edged corners.

12. The mountable decorative holder of claim 1, wherein the backer is one of wood, acrylic solid surface, acrylic glass, steel, brass, copper, and aluminum finish.

13. The mountable decorative holder of claim 1, wherein the pair of side support rods and the bottom support rod are acrylic glass.

14. The mountable decorative holder of claim 1, wherein the mountable decorative holder is configured for use in both portrait and landscape configurations.

15. The mountable decorative holder of claim 1, wherein the pair of side support rods and the bottom support rod are secured to the backer and face plate with a liquid weld solvent.

16. The mountable decorative holder of claim 1, wherein the pair of side support rods and the bottom support rod are secured to the backer and face plate with an adhesive tape.

17. The mountable decorative holder of claim 1, further comprising:
an easel stand upon which to mount the mountable decorative holder for display on top of a planar surface underneath a base of the easel stand.

18. The mountable decorative holder of claim 1, further comprising:
a perpendicular mount, wherein the mountable decorative holder is configured for mounting perpendicular to a planar surface in the perpendicular mount.

19. The mountable decorative holder of claim 1, further comprising:
a plurality of face plates; and
a plurality of pockets disposed upon the backer, created from a plurality of side support rods and a plurality of bottom support rods, such that multiple items are displayed in the mountable decorative holder.

20. The mountable decorative holder of claim 1, further comprising:
a Braille identifier disposed upon the mountable decorative holder to enable the seeing impaired.

21. A method for interchangeably displaying interchangeable printed material, the method comprising:
utilizing a mountable decorative holder for displaying interchangeable printed material comprising: a backer, the backer being mountable to a planar surface; a face plate, the face plate being less in both width and length than the backer and being generally clear such that any interchangeable printed material disposed between the backer and the face plate is viewable through the face plate; and a pair of side support rods and a bottom support rod disposed upon a front surface of the backer and upon which the face plate is disposed, thereby forming a thin pocket accessible from in front of the backer and immediately behind a top of the face plate of the mountable decorative holder in which to place the interchangeable printed material, the bottom support rod being less than a width of the face plate disposed upon it such that at least one gap is formed along a bottom of the pocket of the mountable decorative holder, thereby providing an opening through which to remove accumulated debris with water or compressed air; and wherein the mountable decorative holder is accessible without tools to interchange printed material;
mounting the decorative holder to a planar surface; and
inserting an interchangeable printed material for display within the mountable decorative holder.

22. The method of claim 21, further comprising:
mounting the decorative holder to a planar surface comprising an easel stand.

23. The method of claim 21, further comprising:
mounting the decorative holder to a planar surface, wherein the decorative holder is perpendicular to the planar surface.
